(19) United States
(12) Patent Application Publication
(10) Pub. No.: US 2020/0310937 A1
(43) Pub. Date: Oct. 1, 2020

(54) DEVICE, SYSTEM LSI, SYSTEM, AND STORAGE MEDIUM STORING PROGRAM

(71) Applicants: Kabushiki Kaisha Toshiba, Tokyo (JP); Toshiba Electronic Devices & Storage Corporation, Tokyo (JP)

(72) Inventor: Akira Takeda, Kawasaki Kanagawa (JP)

(21) Appl. No.: 16/562,707

(22) Filed: Sep. 6, 2019

(30) Foreign Application Priority Data
Mar. 25, 2019 (JP) 2019-055859

(51) Int. Cl. G06F 11/34; G06F 9/54; G06F 9/50; G06F 11/30

(52) U.S. Cl. CPC G06F 11/3404; G06F 11/3006; G06F 9/505; G06F 9/547

(57) ABSTRACT

According to one embodiment, a device is connected to a system LSI. The device includes a processor and a memory. The processor causes the system LSI to execute a first RPC process. The processor causes the system LSI to store an. information used when the system LSI executes the first RPC process. The processor causes the system LSI to execute a second RPC process based on the information. The processor obtains a result of the second

### CROSS-REFERENCE TO RELATED APPLICATIONS

This application is based upon and claims the benefit of priority from the Japanese Patent Application No. 2019-055859, filed Mar. 25, 2019, the entire contents of which are incorporated herein by reference.

### FIELD

Embodiments described herein relate generally to a device, a system LSI, a system, and a storage medium storing a program.

### BACKGROUND

In order to estimate the performance of a system LSI, parts of an application are offloaded on the system LSI as an actual machine and executed in a distributed manner to measure the performances of the respective parts on the system LSI, followed by summation to estimate the overall performance. This distributed execution is called Remote Procedure Call (RPC).

For heterogeneous multicore processor (HMP) system, which is dominant among system LSIs in recent years, it is not easy to estimate the performance of parallel software running thereon. This is because possible contention of resources, such as a DSP, a hardware accelerator, a memory and a bus, varies the execution time periods for parallelized tasks. In an RPC operating state, there is an overhead due to the RPC. Accordingly, the state of contention of resources cannot be well represented. It is difficult to estimate the performance of the system LSI correctly.

### BRIEF DESCRIPTION OF THE DRAWINGS

FIG. 1 shows a configuration of a system of an example comprising a performance estimation apparatus in an embodiment;

FIG. 2 shows a data structure of an example of a storage of a host PC;

FIG. 3A shows an overview of processes in the system;

FIG. 3B shows an. overview of process (ST1) in the system;

FIG. 3C shows an overview of process (ST2) in the system;

FIG. 3D shows an overview of process (ST3) in the system;

FIG. 3E shows an overview of process (ST4) in the system;

FIG. 4A shows the former half of a flowchart showing a system usage sequence;

FIG. 4B shows the latter half of the flowchart showing the system usage sequence;

FIG. 5 is a flowchart showing a processing sequence of an. RPC node creation API;

FIG. 6 is a flowchart showing a processing sequence of a reexecution API;

FIG. 7 is a flowchart showing a processing sequence of a node grouping 7PI;

FIG. 8A shows an overview of processes in a reexecution phase in the system;

FIG. 8B shows an. overview of process (STS) in the system;

FIG. 8C shows an overview of process (ST2′) in the system;

FIG. 8E shows an overview of process (ST3′) in the system;

FIG. 9 is a flowchart showing a processing sequence of a reexecuter of a board;

FIG. 10 is a flowchart showing processes of a worker thread;

FIG. 11 is a flowchart showing a processing sequence of a timer thread;

FIG. 12 illustrates advantageous effects of the system; and

FIG. 13 shows a data structure of another example of a memory on a board.

### DETAILED DESCRIPTION

In general, according to one embodiment, a device is connected to a system LSI. The device includes a processor and a memory. The processor causes the system LSI to execute a first RPC process. The processor causes the system LSI to store an information used when the system LSI executes the first RPC process. The processor causes the system LSI to execute a second. RPC process based on the information. The processor obtains a result of the second. RPC process from the system LSI.

Hereinafter, an embodiment will be described with reference to the drawings. In the following description, the same components are assigned the same symbols, and the description thereof is omitted.

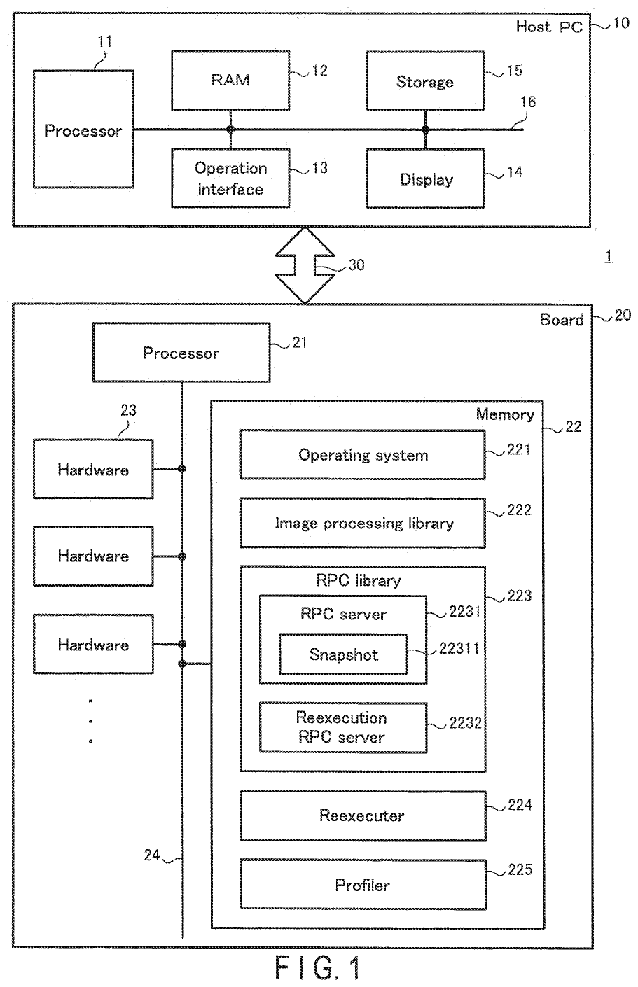

FIG. 1 shows a configuration of a system of an example comprising a performance estimation apparatus in the embodiment. A system 1 comprises a host PC 10, and a (actual machine) board 20. The host PC 10 and the board 20 are communicably connected to each other via a communication interface 30. As a communication I/O, interfaces, such as PCIe and Ethernet (TM) are used, for example.

The host PC 10 as a device comprises a processor 11, a RAM 12, an operation interface 13, a display 14, and a storage 15. The processor 11, the RAM 12, the operation interface 13, the display 14 and the storage 15 are connected to each other via a bus 16.

The processor 11 is, for example, a CPU. The processor 11 performs various processes in the host PC 10. The processor 11 may be, a multicore CPU.

The RAM 12 is a readable and writable semiconductor memory. The RAM 12 is used as a working memory for various processes by the processor 11.

The operation interface 13 is a keyboard, a mouse, etc. The operation interface 13 is an interface for allowing a user to operate the host PC 10.

The display 14 is a liquid crystal display or the like. The display 14 displays various screens. The storage 15 is, for example, a hard, disk. The storage 15 stores an operating system (OS), programs, APIs (Application Programing Interfaces) and the like. According to the programs and the like, which are stored in the storage 15, the processor 11 executes functions designated by these programs.

The details of the board 20 are described. later.

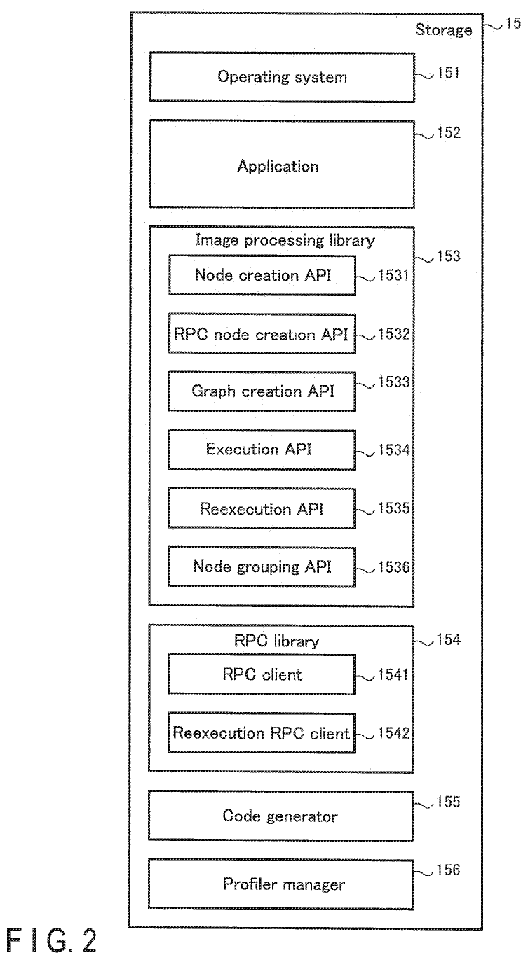

FIG. 2 shows a data structure of an example of the storage 15. The storage 15 stores an operating system (OS) 151, an application 152, an image processing library 153, an RPC (Remote Procedure Call) library 154, a code generator 155, and a profiler manager 155. The RPC is a protocol for offloading parts of an application onto the board 20, and achieving distributed execution.

The OS 151 is a control program for controlling the entire operations of the host PC 10.

The application 152 is an application that operates on the OS 151 and the image processing library 153. The application 152 is an application assumed to be ported to the board 20, such as an image recognition application, for example. It is assumed that the application can be represented by a task graph (operation graph). The task graph is a graph that represents connection between processes (tasks), as connection between nodes. The application 152 receives an input by the user using the node creation API 1531 and the RPC node creation API 1532, creates nodes and RPC nodes that represent corresponding processes, causes the graph creation API 1533 to create a task graph from the set of nodes, and subsequently receives an input by the user and calls the execution API 1534 to execute a task graph process. The application 152 is not limited to an image recognition application.

The image processing library 153 is a library used for an image processing application. The image processing library 153 includes an image processing framework, such as OpenVX, for example. The image processing library 153 includes a node creation APT 1531, an RPC node creation API 1532, a graph creation API 1533, an execution API 1534, and a reexecution. API 1535. The APIs are interfaces for allowing the image processing application to use the functions of the OS 151.

The node creation API 1.531 is an API for creating processes of the application 152 as nodes. A node represents an aggregation of processes (task) on the application 152.

The RPC node creation API 1532 is an API for creating a node for calling an RPC (hereinafter, an RPC node).

The graph creation API 1533 is an API for creating task graph that represents the application 152, from nodes created by the node creation API 1531 or the RPC node creation API 1532. The task graph of the application 152 is represented by the graph creation API 1533, as any of a task graph including all the nodes (hereinafter, called an all-node graph:) or a task graph including only RPC nodes (hereinafter, called an RPC node graph).

Here, the RPC node graph can be created from the all-node graph. For example, the user describes an interface of a function (function declaration.) to be clipped from the application 152 for the board 20, in an IDL (Interface Description Language). The interface of the function includes an argument (s) , a return value (s) and the like of the function. The arguments of the functions include, for example, designation of a group of functions, and the RPC nodes for calling them. The user uses the RPC node creation API 1532 to create the RPC node from the clipped interface of the function. The RPC node includes the names of (a plurality of) functions associated with IDs, the number of forward-dependent nodes, and a backward-dependent node ID list. The forward-dependent node is a formar node among nodes dependent on each other. The backward-dependent node is a latter node among nodes dependent on each other. For example, if the processing result of the former node is used by a process of the latter node, the latter node has a forward-dependency on the former node. The RPC node graph is a set of RPC nodes.

The execution API 1534 is an API for executing the processes of the all-node graph.

The reexecution API 1535 is an API for executing RPC node graph processing. The reexecution API 1535 is called immediately after the execution API 1534. The arguments of the reexecution API 1535 include the input period and the number of repetitions. The input period indicates the execution period of an RPC node serving as a source when reexecution. is performed in a pipelined manner. The number of repetitions indicates the times of repetitions of input during reexecution. The internal process of the reexecution API is executed as a reexecution RPC in actuality.

The image processing library 153 may include a node. grouping API 1536 for grouping RPC nodes. The set of grouped RPC nodes may be processed as single RPC node through this interface. When grouping is made, the grouped RPC nodes are sequentially executed on. the identical thread, but are not executed in parallel. The node grouping API 1536 may be included in a library other than the image processing library 153, in conformity with an embedding situation of the host PC 10.

The RPC library 154 is a library used for the RPC. In the RPC library 154, an RPC client 1541 and a reexecution RPC client 1542 are generated by the code generator 155.

The code generator 155 generates codes usable by the host PC 10 and the board 20, from the IDL described by the user. For example, in a case where an interface of a function is described in the IDL by the user, the code generator 155 automatically generates the RPC client 1541, the reexecution RPC client 1542, an RPC server and a reexecution RPC server, from the IDL. The RPC client 1541 and the reexecution RPC client 1542 are executed on the host PC 10. The RPC server and the reexecution RPC server are executed on the board 20.

The profiler manager 156 causes the display 14 to display a measurement result by an after-mentioned profiler 225 of the board 20, in text or graphics.

Returning to FIG. 1, the description is continuously made. The board 20 is a system LSI that comprises a processor 21 and a memory 22. Various pieces of hardware 23 required for the respective LSIs are embedded on the board 20. The processor 21, the memory 22 and the hardware 23 are connected to a bus 24.

The processor 21 for example, a CPU. The processor 21 performs various processes on the board 20. The processor 21 may be a multicore CPU or the like.

The memory 22 may be, for example, a flash memory. The memory 22 stores an operating system (OS) 221, an image processing library 222, an RPC library 223, a reexecuter 224, and a profiler 225. On the board 20, the image processing library 222 and the RPC library 223 operate on the OS 221.

The image processing library 222 comprises a library for image processing. The image processing^{.} library^{.} 222 can offload processes on a hardware accelerator, a DSP (Digital Signal Processor) and the like, which are embedded as pieces of hardware 23 of the board 20.

The RPC library 223 is a library used for the RPC. In the RPC library 223, an RPC server 2231 and a reexecution RPC server 2232 are generated by the code generator 155 of the host PC 10. Upon receipt of a function process request issued by the RPC client 1541, the RPC server 2231 performs the function process. The function can offload the process onto the hardware accelerator, the DSP and the like, by calling the image processing library 222. At the initial execution, the RPC server 2231 records a history of called functions with respect to each RPC node. The association relationship between the function and the RPC node is described in the IDL, for example. The RPC server 2231 has a snapshot function of entirely storing the state at the time. The RPC server 2231 obtains inputs (argument(s) and return value(s)) of the function in immediately previous execution, with respect to each called function, and stores the inputs as a snapshot 22311.

The reexecuter 224 receives a reexecution command from the host PC 10, the RPC node graph, the input period, and the number of repetitions, and executes the function associated with each RPC node in a pipelined manner, based on the dependency of each RPC node in the RPC node graph. The function associated with each. RPC node is executed, in. every input period, for times as many as the-number-of-repetitions. However, this applies to the RPC node having no forward-dependency on another RPC node. As for the RPC node having a forward-dependency on another RPC nodes, completion of execution of the all forward-dependent RPC nodes is waited, and subsequently the function associated with the RPC node is executed. As described above, the execution in a pipelined manner means that the function associated with each RPC node is executed in every input period, for times as many as the number of repetitions while RPC nodes with. forward-dependency wait for execution completion of all dependent RPC nodes.

The profiler 225 operates on the lowermost layer of the board 20. The profiler 225 measures the execution time period of the function, and obtains the performance monitor value of the. bus. When the measurement is completed or the measurement amount reaches a predetermined amount, the profiler 225 transmits the measurement result to the profiler manager 156 of the host PC 10.

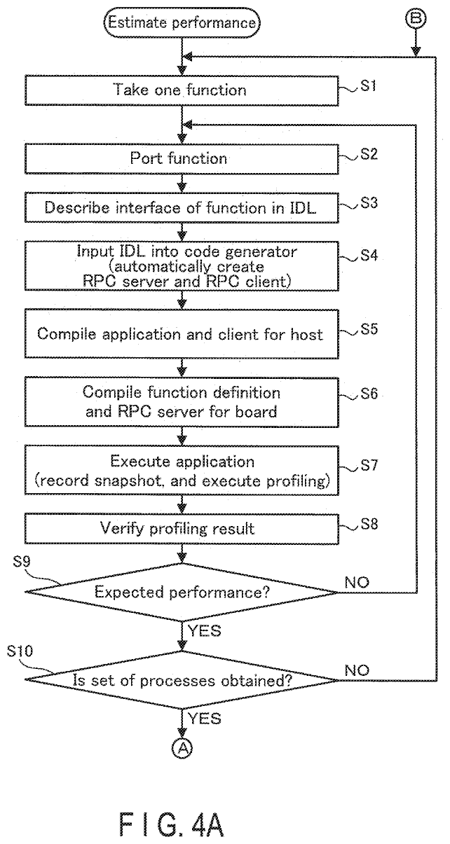

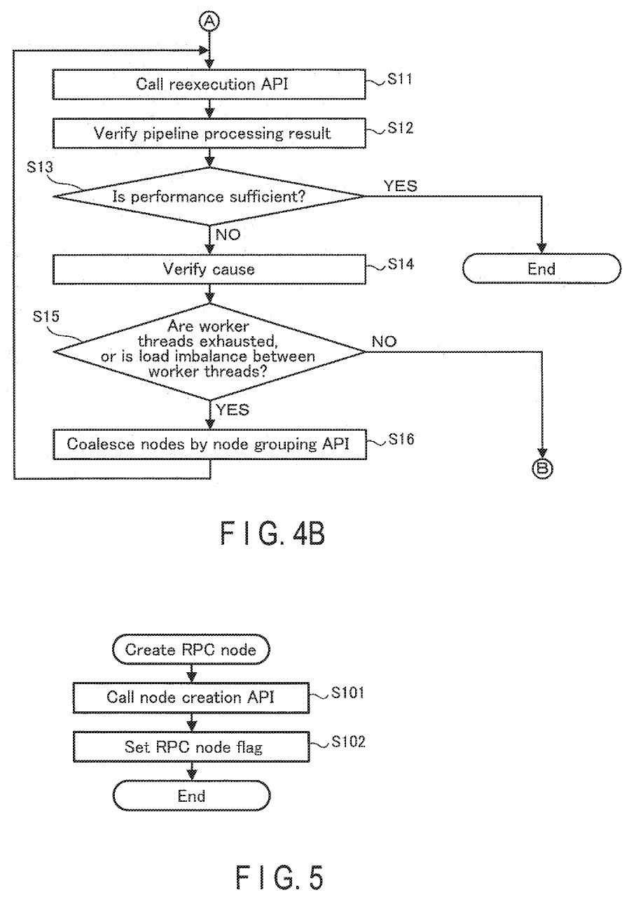

Hereinafter, the flow of processes in. the system 1 is described. FIG, 3A shows an overview of processes in. the system 1. A specific flowchart is described later with reference to FIGS. 4A and 4B.

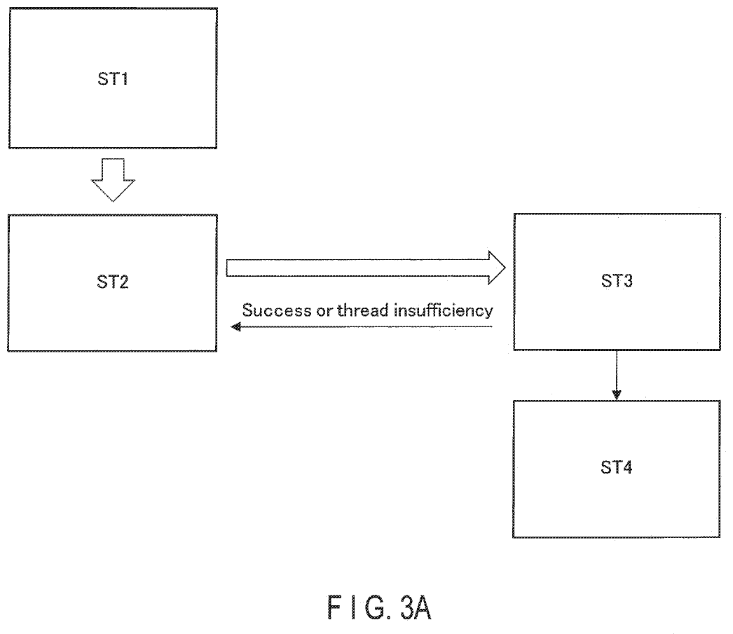

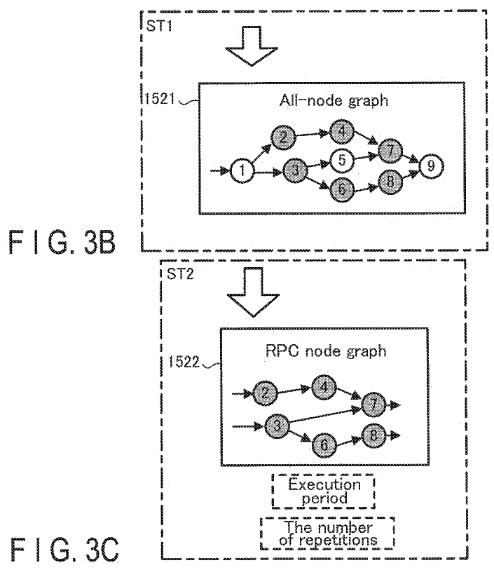

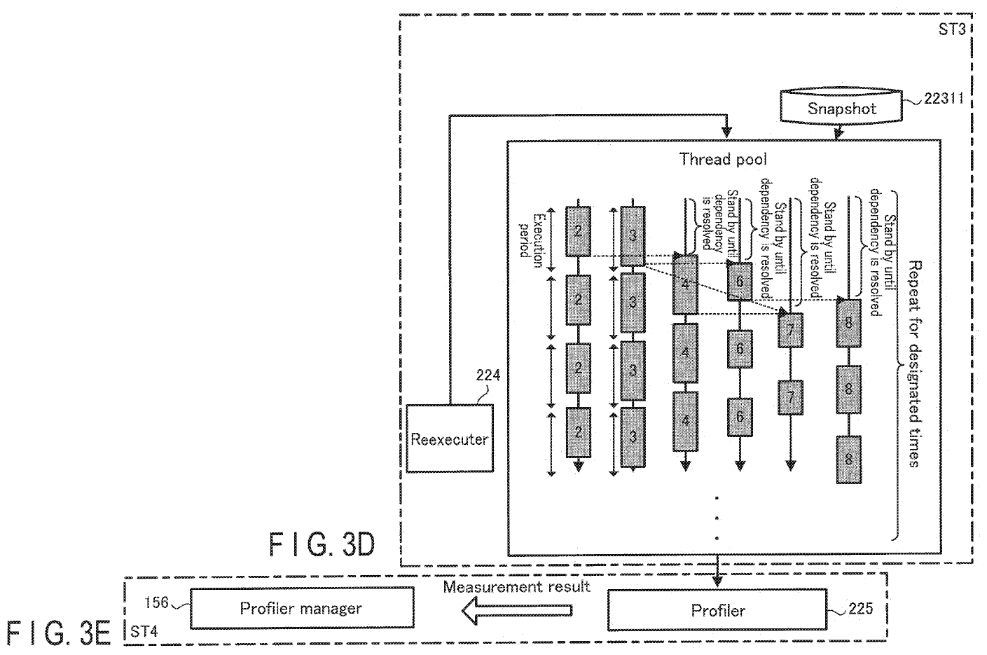

Processes in the system 1 include a process (ST1), a process (ST2), a process (ST3), and a process (ST4), shown in FIG. 3A. The flow of each of the processes is described below.

FIG. 3B shows an overview of process (ST1) in the system 1. The user activates the application 152. The application. 152 calls the node creation API 1531 and the RPC node creation API 1532 according to an instruction by the user. Upon receipt. of an input by the user using the node creation API 1531 and the RPC node creation API 1532, the application 152 creates a node. Subsequently, the application 152 calls the graph creation. API 1533 to create an all-node graph 1521, in response to an instruction by the user. Subsequently, the application 152 calls the execution API 1534 to temporarily execute the process according to the all-node graph 1521, according to an operation. by the user. In the all-node graph 1521 in FIG. 3B, nodes are indicated by circles. Outlined blank circles represent normal nodes. Hatched circles represent nodes designated by the user as RPC nodes. Node numbers are assigned for discriminating the nodes from each other. It does not necessarily mean that the processing i8 performed in this order. Arrows between nodes indicate the order of the processes, and represent the dependency with respect to use of processing results.

The normal nodes are executed by the host PC 10, Meanwhile, the processes of the RPC nodes are executed by the board 20. That is, after the application 152 calls the function via the RPC client 1541, the RPC client 1541 transmits a function process request to the RPC server 2231 on the board 20 via the RPC library 154, and a communication driver in the OS 151.

After the process for the RPC node is performed, the RPC server 2231 uses the snapshot function to store the input history of each function (the arguments of the function) as the snapshot 22311.

FIG. 3C shows an overview of process (ST2) in the system 1. After calling the execution API 1534, the application 152 calls the reexecution API 1535. The application 152 calls the graph creation API 1533 and converts the all-node graph 1521 into an RPC node graph 1522. The application 152 passes a set of the RPC node graph 1522, the execution period, and the number of repetitions, to the reexecuter 224 on the board 20 via the RPC library 154 and the communication driver in the OS 151.

FIG. 3D shows an overview of process (ST3) in the system 1. The reexecuter 224 allocates a node to a thread in a thread pool, and executes the process of the RPC node graph 1522 based on the input history stored as the snapshot 22311. In the thread pool in FIG. 3D, arrows extending in the vertical direction represent the respective worker threads, and a rectangle represents a thread associated with a node. Here, the number of each RPC node of the RPC node graph 1522 is assigned to indicate the association relationship between the thread and the RPC node. The input history stored as the snapshot 22311 is used as an input, because the RPC node graph 1522 is a subgraph from. the all-node graph 1521. Input and output between dependent RPC nodes do not necessarily correspond to each other. For example, in FIG. 3D, an RPC node 3 and an RPC node 7 have a dependency. However, in view over the all-node graph 1521, a node 5 resides between the node 3 and the node 7. Consequently, the output of the RPC node 3 does not correspond to the input of the RPC node 7. Grouped RPC nodes as described later are allocated to the same thread. If there are a plurality of RPC nodes having not been grouped, the RPC nodes are respectively allocated to the thread to be executed in parallel. No RPC node is allocated to threads to which nodes have already been allocated. A thread corresponds to a core of the processor 21, for example.

The processes of-the worker threads are executed. basically at intervals designated by the execution period. However, if there are dependencies between RPC nodes, the processing stands by until the dependency is resolved, that is, the processes for the forward-dependent RPC nodes are completed. For example, in FIG. 3D, an RPC node 4 has a forward-dependency on an RPC node 2. Accordingly, the process for the RPC node 4 stands by until the process for the RPC node 2 is completed. Likewise, the RPC node 7 has forward-dependencies on the RPC node 4 and the RPC node 3. Accordingly, the process for the RPC node 7 stands by until the processes for both the RPC node 4 and the RPC node 3 are completed. Such a process for each RPC node is repeated for times as many as the number designated by the number of repetitions. If the worker threads are exhausted, a warning message of exhaustion is transmitted to the profiler manager 156 of the host PC 10. Meanwhile, the processing continues as it is.

FIG. 3E shows an overview of process (ST4) in the system 1. The profiler 225 obtains the profile during execution of the process of the worker thread. When the measurement is completed or the measurement amount reaches a predetermined amount, the profiler 225 transmits the measurement result to the profiler manager 156 of the host PC 10. The profiler manager 156 displays the measurement result by the profiler 225 of the board 20 in a format appropriate for the user.

Hereinafter, the flow shown. in FIGS. 3A to 3E is more specifically described. FIGS. 4A and 4B show the flowchart showing the usage sequence of the system. 1 of the embodiment.

In Step S1, the user activates the application 152, and uses the node creation API 1531 to clip a function intended to be measured on the board. 20.

In Step S2, the user ports (coding) the clipped function so as to be executable on the board 20. In Step 53, the interface of the function is described in IDL.

In Step S4, the user inputs the IDL into the code generator 155. Accordingly, the code generator 155 automatically generates the RPC server 2231 for the board 20 and the RPC client 1541 for the host PC 10.

The user changes a call for the-node creation API 1531 that creates a node of interest, to a call for the RPC node creation API 1532 that creates an RPC node, on the application 152.

FIG. 5 is a flowchart showing a processing sequence of the RPC node creation API 1532. The processes in FIG. 5 are executed by the user calling the RPC node creation API 1532 on the application 152. In. Step S101, the application 152 calls the node creation API 1531, which is an API for creating a normal node. In Step S102, the application 152 sets an RPC node flag that indicates that the node is a node for calling an RPC, for the node that is to process the function designated by the user. Subsequently, the application 152 finishes the processes in FIG. 5.

After completion of the above operation, in Step S5 in FIG. 4A, the user causes a compiler for the host PC to compile the application 152 and the RPC client 1541. In Step S6, a compiler compiles the implemented code of the function and the RPC server 2231 for the board.

After completion of compiling, in Step S7, the user temporarily executes the application 152. Execution of the application allows the RPC node to issue an RPC, and obtains the profile of each function and the snapshot 22311 of an input, on the board 20. After the execution of the application is completed, profile data is transmitted from the profiler 225 of the board 20 to the profiler manager 1.56 of the host PC 10.

In Step S8, the user verifies a profile result visualized by the profiler manager 156.

In Step S9, the user then determines whether the profile result is a result indicating an expected performance or not. In Step S9, if it is determined that the expected performance is not obtained, the user performs the coding in Step S2 again. If it is determined that the expected performance is obtained, the processing proceeds to Step S10.

In Step S10, the user determines whether a set of processes intended to be measured. on the board 20 has been obtained. If it is determined that the set of processes intended to be measured on the board 20 has not been obtained yet in Step S10, the user performs the function taking in Step S1 again. Thus, the RPC nodes to be processed are increased. If it is determined. that the set of processes intended to be measured on an actual machine is obtained in Step S10, the processing proceeds to a pipeline reexecution phase from Step S11.

The processes of Step Si to Step S10 are included in the process (STI).

In the pipeline reexecution phase, in Step S11 in FIG. 43, the user calls the reexecution API 1535 on the application 152.

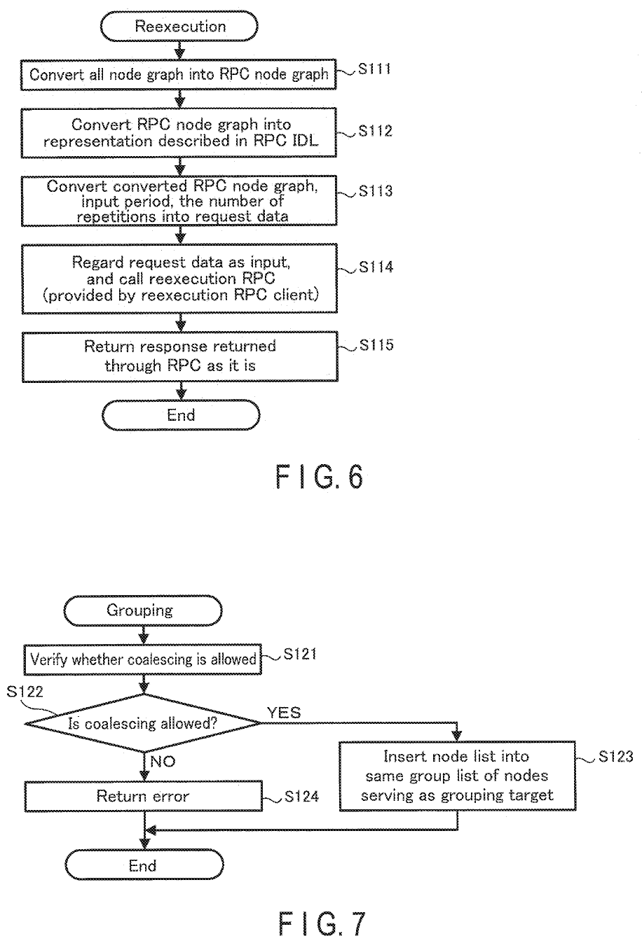

FIG. 6 is a flowchart showing a processing sequence of the reexecution API 1535. The processes in FIG. 6 are executed by the user calling the reexecution API 1535 through the application 152. In. Step S111, the application 152 calls the graph creation API 1533 to create the RPC node graph 1522 from the all-node graph 1521. The RPC node graph 1522 is obtained by sequentially removing nodes where the RPC node flag is not set, from the all-node graph 1521.

In Step S112, as for the representation of the RPC node graph 1522, the application 152 converts the internal representation of the image processing library 153 into a representation described in IDL.

In Step S113, the application 152 converts, the RPC node graph 1522 obtained by conversion, and the input period and the number of repetitions designated by the user, into request data

In Step S114, the application 152 passes the request data (the RPC node graph 1522, the input period, and the number of repetitions), as arguments, to the reexecuter 224 on the board 20 via the reexecution RPC client 1542 and the communication. driver in the OS 151.

The processes of Step S11 and Step S111 to S114 are included in the process (ST2).

As described later in detail, the reexecuter 224 allocates a node to a thread, adopts, as an input, the input history stored as the snapshot 22311, and executes the process of the RPC node graph 1522. The profile at execution of the process of the worker thread is obtained by the profiler 225, and is transmitted to the host PC 10.

In Step S115, the application 152 returns, to the profiler manager 156, the response returned from the board 20 through the RPC, as it is. This response includes information on whether the process on each thread has been performed on the board 20 or not, for example. Subsequently, the application 152 finishes the processes in FIG. 6. The process of Step S115 is included in the process (ST3).

Returning to FIG. 4B, the description is continuously made. In Step S12, the profiler manager 156 visualizes a response from the board 20 obtained by the process by the reexecution API 1535 to display as a result of the pipeline process. The user verifies this. The process of Step S12 is included in the process

In Step S13, as a result of this confirmation, the user determines whether a desired performance is obtained on the board 20 or not. If it is determined that the desired performance is obtained in Step S13, the user finishes the processes in 4A and FIG. 4B. If it is determined that the performance of the board 20 is not sufficient in Step S13, the processing proceeds to Step S14.

In Step S14, the user verifies the cause of insufficiency of the performance.

In Step S15, the user determines whether or not the cause of insufficiency of the performance is exhaustion of worker threads or load imbalance between worker threads (or available worker threads are present). If it is determined that exhaustion of worker threads or load imbalance between worker threads is the cause of insufficiency of the performance in Step S15, the user performs the process in Step S16. If it is determined that the cause is another cause in. Step S15, the performance of the board 20 is essentially insufficient. Accordingly, the parameters of the bus are adjusted, or the processing returns to the actual machine porting phase in order to perform estimation in a case of further optimization, such as use of SIMD (Single Instruction/Multiple Data) instructions, or the processing returns to correction of a reference application in order to modify the algorithm. To estimate the performance of the board 20 after the correction, the user performs the operations from Step S1 again.

In Step S16, the user uses the node grouping API 1536 to make RPC nodes coalesce into one group. Subsequently, the user performs again the processing from the process in Step S11, which is the beginning of the reexecution phase.

FIG. 7 is a flowchart showing a processing sequence of the node grouping API 1536. The processes in FIG. 7 are executed by the user calling the node grouping API 1536 on the application 152. In Step S121, the application 152 verifies whether the RPC nodes can coalesce or not.

In Step S122, the application 152 determines whether these nodes can coalesce or not as the result of the verification in Step S121. If it is determined that the nodes can coalesce in. Step S122, the application 152 advances the processing to Step S123. If it is determined that the nodes cannot coalesce in Step S122, the application 152 advances the processing to Step S124. If an edge of input from the RPC node out of the group or output to the RPC node out the group is included between the RPC nodes, the application 152 determines that the processes cannot coalesce,

In Step S123, the application 152 inserts a node list into the same group list of RPC nodes that are grouping targets. Subsequently, the application 152 finishes the processes in. FIG. 7.

In Step S124, the application 152 returns an error code. Subsequently, the application 152 finishes the processes in FIG. 7.

The process of Step S16 and the process of Step S121 to 124 are included in a process (STS). The detail of the process (ST5) is described below.

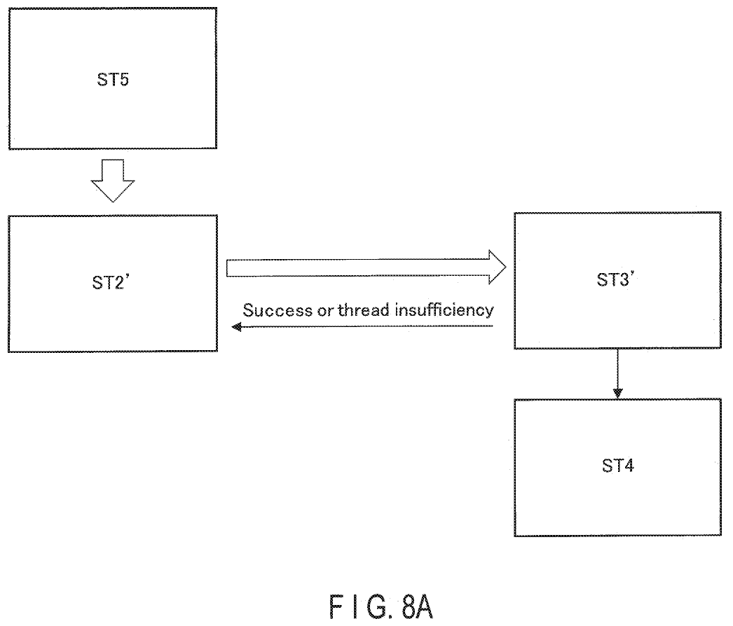

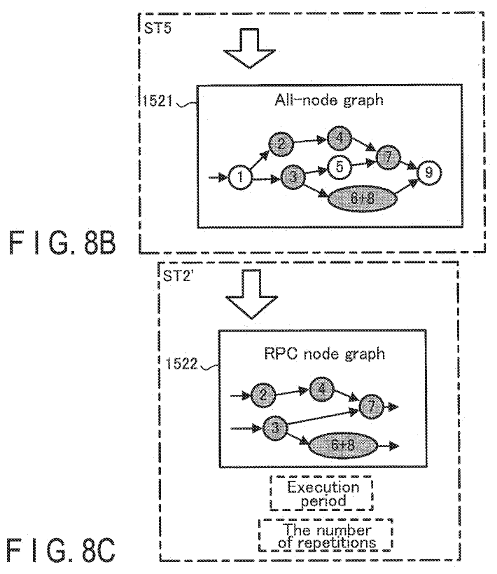

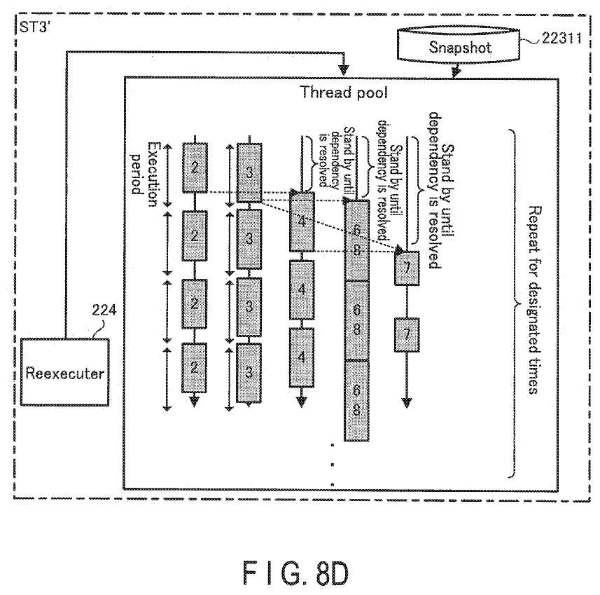

FIG. 8A shows an overview of processes in the reexecution phase in the system 1. Processes in the system 1 include a process (ST1), a process (ST2′), a process (ST3′), a process (ST4), and a process (ST5), shown in FIG. 8A.The process (ST1) in FIG. 3A is replaced with the process (ST5) in FIG. 8A. The process (ST4) in FIG. 8A corresponds to the process (ST4) in FIG. 3A. The description of the process (ST4) in FIG. 8A are omitted. If the number of worker threads (=the number of cores in execution of the processes) is exhausted, or if the performance cannot be well achieved due: to the load imbalance between worker threads, the user makes the dependent nodes coalesce into one group.

FIG. 8B shows an overview of process (STS) in the system 1. In FIG. 8B, the node 6 and the node 8 coalesce into an integrated node based on the fact that the utilization of the thread executing an RPC node 6 is not high (see FIG. 3B). When the node 6 and the node 8 are specified as arguments of the node grouping API 1536, the nodes 6 and 8 are internally processed as an integrated node.

FIG. 8C shows an overview of process (ST2′) in the system 1. The application 152 calls the reexecution API 1535. The application 152 calls the graph creation API 1533 and converts the all-node graph 1521 into the RPC node graph 1522. In. this case, the nodes 6 and 8, which have coalesced into one in the all-node graph, are converted into an RPC node. The application 152 then passes again a set of the RPC node graph 1522, the execution period, and the number of repetitions, to the reexecuter 224 on the board 20 via the RPC library 154 and the communication driver in. the OS 151.

FIG. 8D shows an overview of process (ST3′) in the system 1. As described above, as a result of execution with grouping, a worker thread. becomes available with respect to the state before the reexecution phase shown in FIG. 3D. Accordingly, a RPC process can be added.

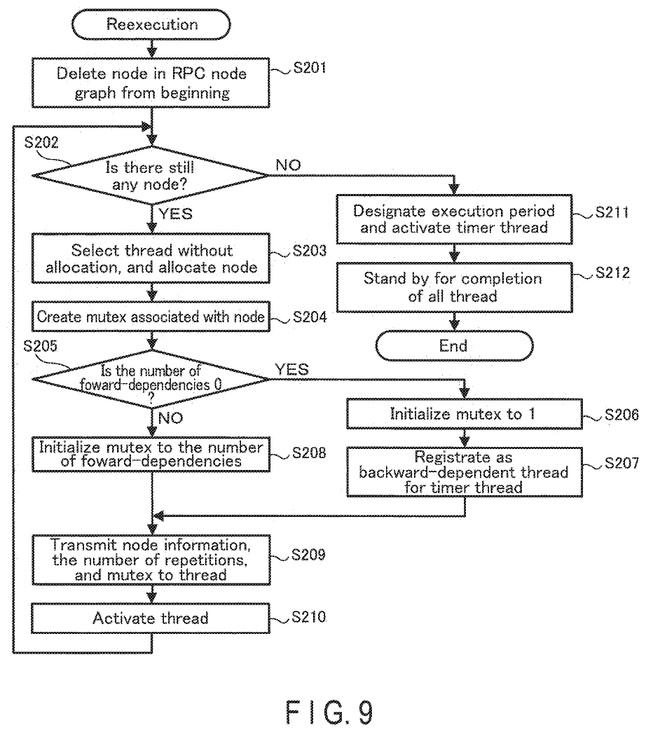

FIG. 9 is a flowchart showing a processing sequence of the reexecuter 224 of the board 20. In Step S201, the reexecuter 224 deletes the RPC nodes from the RPC node graph 1522 sequentially from the beginning.

In Step S202, the reexecuter 224 determines whether or not there is an. RPC node in the RPC node graph 1522. If it is determined that an RPC node in the RPC graph 1522 is present in Step S202, the processing transitions to Step S203. If it is determined that an RPC node in the RPC node graph 1522 is not present among in. Step S202, the processing transitions to Step S211.

In Step S203, the reexecuter 224 allocates the deleted RPC nodes to a queue of the worker thread to which allocation has not been made yet.

In Step S204, the reexecuter 224 creates a mutex associated with the allocated RPC node.

In Step S205, the reexecuter 224 determines whether the number of forward-dependencies of the allocated RPC node is zero or not. In other words, it is determined whether the allocated node is the beginning node among the RPC nodes or not. If it is determined whether the number of forward-dependencies of the allocated. RPC node is zero in Step S205, the processing transitions to Step S206. If it is determined whether the number of forward-dependencies of the allocated RPC node is not zero in Step S205, the processing transitions to Step S208.

In Step S206, the reexecuter 224 initializes the mutex to one.

In Step S207, the reexecuter 224 registers the allocated RPC node (beginning node) as a node to be periodically activated by the timer thread. Subsequently, the processing transitions to Step S209. The worker thread corresponding to the beginning node is the backward-dependent thread of the timer thread.

In Step S208, the reexecuter 224 initializes the mutex to the number of forward-dependencies of the allocated RPC node (numDep). The mutex is decremented by forward-dependent worker threads. The worker thread corresponding to the allocated RPC node stands by until the mutex becomes zero. Subsequently, the processing transitions to Step S209.

In Step S209, the reexecuter 224 transmits the RPC node information, the number of repetitions, and the mutex, to the worker thread. to which the RPC node is allocated. The P.P. node information includes, for example, the ID of the RPC node, a group of functions to be executed in the RPC node (the function names and the function entities), the number of dependent items of the RPC node, and the list of backward dependent threads. The group of functions includes one or more function names (funcName) indicating the names of functions to be executed, and function entities that are entities of the functions that are associated with the respective function names and to be actually executed.

In Step S210, the reexecuter 224 activates a worker thread to which RPC node allocation has been completed. Subsequently, the reexecuter 224 returns the processing to Step S202.

In Step S211 after completion of the RPC node allocation, the reexecuter 224 designates the execution period and activates a timer thread. The number of repetitions, and the list of backward-dependent threads are provided as the arguments of the timer thread.

In Step S212, the reexecuter 224 stands by for completion of .he processes of all the worker threads. After the processes of all the worker threads are completed, the reexecuter 224 finishes the processes in FIG. 9.

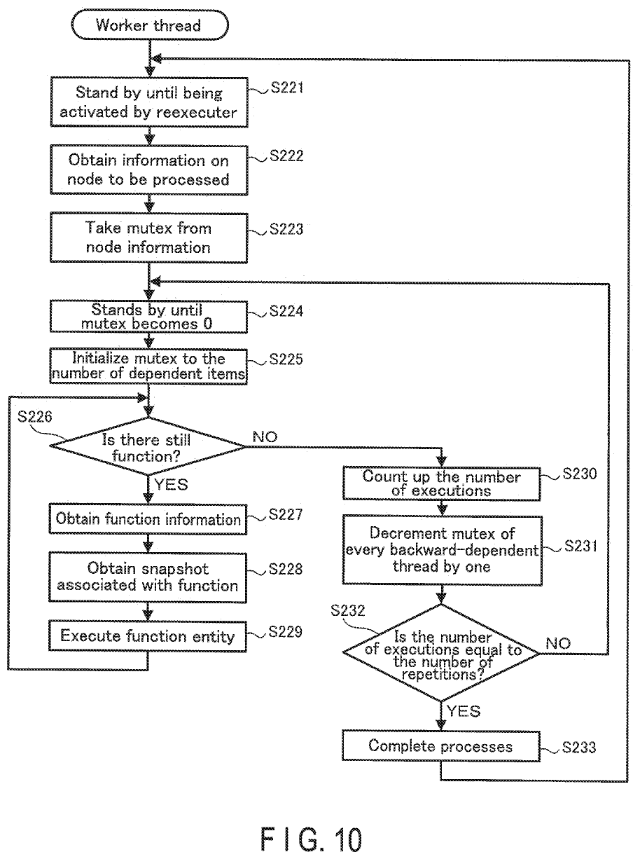

FIG. 10 is a flowchart showing the processes of the worker thread. In Step S221, the worker thread stands by until being activated by the reexecuter 224. After activation by the reexecuter 224, the processing transitions to Step S222.

In Step S222, the worker thread obtains the information on the RPC node to be processed, from the queue.

In Step S223, the worker thread takes the mutex from the obtained node information.

In Step S224, the worker thread stands by until mutex associated with the RPC node is zero or all of processes of the forward-dependent nodes complete. When the mutex becomes zero, the processing proceeds to Step S225.

In Step S225, the worker thread initializes the mutex to the number of dependent items.

In Step S226, the worker thread determines whether there is still a function having not been processed yet. If it is determined that there is still a function having not been processed yet in Step S226, the processing proceeds to Step S227. If it is determined that there is no function having not been processed yet in Step S226, the processing proceeds to Step S230.

In Step S227, the worker thread obtains the function associated with the function name (funcName).

In Step S228, the worker thread obtains the snapshot 22311 associated with the obtained function entity.

In Step S229, the worker thread processes the function. Subsequently, the worker thread returns the processing to Step S226. Until all the functions included in the group of functions are processed, the processes in Steps S226 to 8229 are repeated.

In Step S230 after completion of the processes of all the functions, the worker thread counts up the number of executions.

In Step S231, the worker thread decrements the mutex of every backward-dependent thread.

In Step S232, the worker thread determines whether the number of executions is equal to the number of repetitions or not. If it is determined that the number of executions is not equal to the number of repetitions in Step S232, the processing returns to Step S224. The processing returns to the process of standing by until the mutex becomes zero. If it is determined that the number of executions is equal to the number of repetitions in Step S232, the worker thread finishes the processes in Step 8233. In this case, the worker thread returns the processing to Step s221, and stands by until being activated by the reexecuter 224.

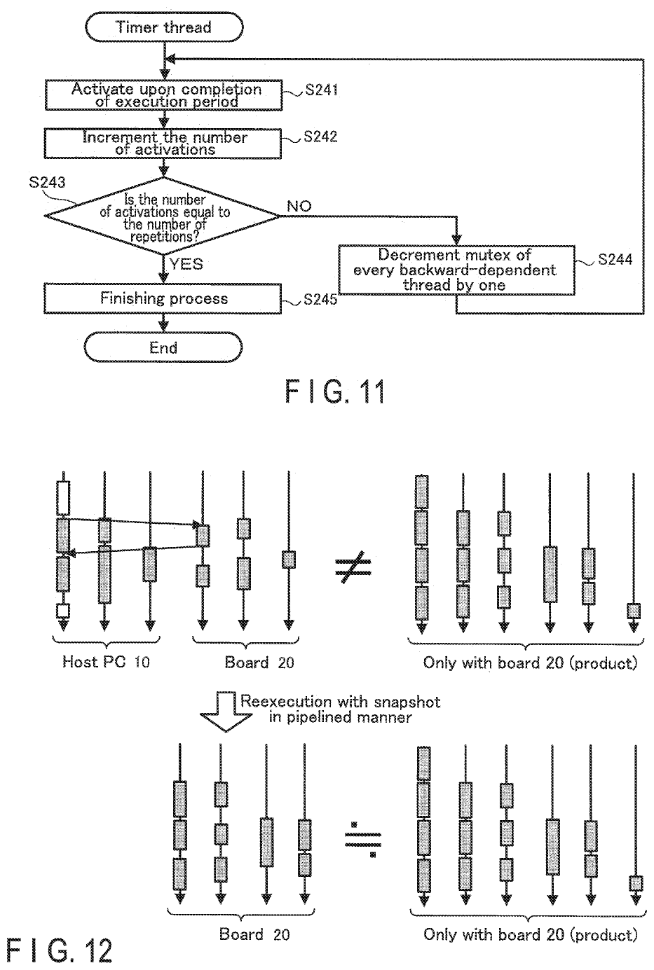

FIG. 11 is a flowchart showing a processing sequence of the timer thread. In Step S241, the timer thread is activated upon completion of the designated execution period.

In Step S242, the timer thread increments the number of activations.

In Step S243, the timer thread determines whether the number of activations is equal to the number of repetitions, that is, whether the number of activations reaches the number of repetitions or not. If it is determined that the number of activations is not equal to the number of repetitions in Step S243, the processing returns to Step S244. If it is determined that the number of activations is equal to the number of repetitions in Step S243, the processing transitions to Step S245.

In Step S244, the timer thread decrements the mutex of every backward-dependent thread. Subsequently, the timer thread returns the processing to Step S241.

In Step S245, the timer thread finishes the processes in FIG. 11.

According to the embodiment described above, the performance of the system. LSI can be more correctly estimated. FIG. 12 illustrates the advantageous effects. If the application 152 is constructed on the host. PC 10 and subsequently the processing time of a main element on the board 20 is measured using the existing RPC technique, there is a large gap between the operation state of an original application developed on the host PC and the operation state of the application ported as a final product with parallelization as shown in an upper part of FIG. 12. Accordingly, the state cannot be regarded a sufficiently estimated state. Here, arrows extending in the vertical direction represent the respective worker threads, and outlined blank rectangles indicate the respective threads associated with normal nodes of the application. Hatched rectangles indicate threads associated with the respective RPC nodes. In this embodiment, while reexecution on the board 20, the snapshot on the board 20 is used as the input of nodes instead, of the results of nodes on the host PC 10, to avoid the contention due to the communication between the host PC 10 and the board 20. Accordingly, as shown in the lower part of FIG. 12, parallel processes with resource contention can be reproduced and profiled. Based on the profiling, the RPC nodes are grouped to reduce the idle time and increase the utilization of worker threads. If available worker thread is obtained. by this reduction, a thread associated with an RPC node can be allocated thereto, and parallel processes can be reproduced and profiled again.

As described above, a plurality of processes offloaded on the board 20 are reconfigured in a pipelined manner, and the parallel processes with resource contention are reproduced and profiled, thereby enabling the performance in a product-embedded case to be more correctly estimated as shown in the lower part of FIG. 12.

Consequently, on a prototyping stage, that is, a stage where the application 152 has not been ported to the board 20 yet and has not been pipeline-parallelized yet either, the performance in a case where the application 152 is pipeline-parallelized and executed on the board 20 can be more correctly estimated (specifically, including resource contention between the memory 22, the bus 24, and the hardware 23, such as an accelerator).

Based on a result of reconfiguration in a pipelined manner, the RPC node can be grouped, and estimation can be performed again.

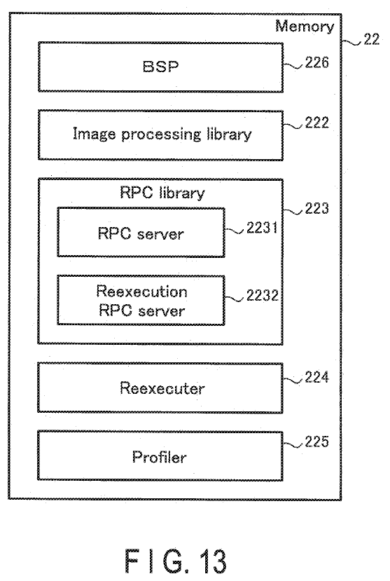

The board 20 is not limited to what includes the OS 221 as shown in FIG. 1. This is applicable also to a case where the OS 221 is not included but a minimum runtime, such as a board support package (BSP), is included. FIG. 13 shows a data structure of an example of a memory 22 of such a board 20. The memory 22 stores a board support package 226, an image processing library 222, an RPC library 223, a reexecuter 224, and a profiler 225. In this case, a runtime does not have multithreading and multitasking functions. Accordingly, the pipeline processes are executed assuming the cores and a processor 21 as threads. The profiler 225 may be configured as a hypervisor.

In the aforementioned embodiment, a first RPC process (ST1) does not include a pipeline execution phase and a second RPC process (ST2) includes a pipeline execution process. The first-RPC process (ST1) may include a pipeline execution. phase. In other word, the second RPC process may be the same as the first RPC process except using the snapshot.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A device connected to a system LSI, comprising:
a processor; and
a memory,
wherein the processor configured to:
cause the system LSI to execute a first remote procedure call (RPC) process,
cause the system LSI to store an. information used when the system LSI executes the first RPC process,
cause the system LSI to execute a second RPC process based on the information, and
obtain a result of the second RPC process from the system LSI.

2. The device according to claim. 1,
wherein the processor is further configured to execute the second RPC process in a pipelined manner based on a designated number of repetitions and a designated execution period.

3. The device according to clam: 1, wherein the processor is further configured to allocate a group of RPC nodes as single RFC node to the system LSI.

4. The device according to claim 1, wherein the processor is further configured to cause the system LSI to perform parallel execution of a plurality of RPC nodes.

5. The device according to claim 1, further comprising a display configured to display the result.

6. A system LSI connected. to a device, comprising:
a processor, and
a memory,
wherein the processor configured to:
execute a first RPC process, according to a request from the device;
store an information used when. the first RPC is executed;
execute a second RPC process based on the information, according to a request from the device; and
transmit a result of the second RPC process to the device.

7. A system comprising:
a device comprising:
a first processor; and
a first memory;
a system LSI connected to the device, comprising:
a second processor; and
a second memory,
wherein the first processor is configured to cause the system LSI to execute a first RPC process,
the second processor is configured to store, in the second memory, an information used when the first RPC is executed;
the first processor is configured to cause the system LSI to execute a second :RPC process based on the information, and
the second processor is configured to transmit a result of the second RPC process to the device.

8. A computer-readable non-transitory storage medium storing a program causing a processor of a device comprising a processor and a memory and connected to a system LSI, to perform:
causing the system LSI to execute a first RPC process;
causing the system. LSI to store an information used when the system LSI executes the first RPC process, and
causing the system LSI to execute a second RPC process based on the information, and
obtaining a result of the second RPC process from the system LSI.

9. A computer-readable non-transitory storage medium storing a program causing a processor of a system LSI comprising the processor and a memory and connected to a device, to perform:
executing a first RPC process, according to a request from the device;
storing, e an information used when the first RPC is executed;
executing a second. RPC process based on the information, according to a request from the device; and
transmitting a result of the second RPC process to the device.
